(19) United States
(12) Patent Application Publication
(10) Pub. No.: US 2026/0140322 A1
(43) Pub. Date: May 21, 2026

(54) MICRO-RING RESONATOR WITH DIRECT CONTACTS, HEATER AND UNDERCUT

(71) Applicant: INTERNATIONAL BUSINESS MACHINES CORPORATION, Armonk, NY (US)

(72) Inventors: Neng Liu, Albany, NY (US); Hsianghan Hsu, Latham, NY (US); Qianwen Chen, Fort Collins, CO (US); John Knickerbocker, Monroe, NY (US)

(21) Appl. No.: 18/953,684

(22) Filed: Nov. 20, 2024

(51) Int. Cl. G02B 6/293

(52) U.S. Cl. CPC G02B 6/29395; G02B 6/29338

(57) ABSTRACT

A semiconductor device includes a micro-ring resonator including a semiconductor ring having a heater portion and a modulator portion integrally formed therein, wherein the semiconductor ring includes a central portion and extended portions radially inside and radially outside the central portion, the extended portions being thinner than the central portion. Contacts connect to the extended portions of the heater portion and the modulator portion on a top and a bottom of the extended portions.

### BACKGROUND

The present invention generally relates to semiconductor devices and processing methods, and more particularly to micro-ring resonators having improved contact connections and stable temperature control.

A data center houses computer systems and associated components, such as telecommunications and storage systems. An important element in a data center includes transceiver devices, which include optoelectronic modulators. Si-based optoelectronic modulators include a vertical P-N junction, which provides low power consumption, low-voltage operation, high-speed, and is compact in size. However, conventional P-N junction micro-disk (micro-ring) resonators employ silicon extensions to connect metal contacts to diffusion regions of the P-N junction. The silicon extensions that connect the metal contacts can result in higher contact resistance, additional heat accumulation and additional power consumption. These parameters can also result in temperature fluctuations that can alter the performance of the micro-disk resonators.

### SUMMARY

In accordance with an embodiment of the present invention, a semiconductor device includes a micro-ring resonator including a semiconductor ring having a heater portion and a modulator portion integrally formed therein, wherein the semiconductor ring includes a central portion and extended portions radially inside and radially outside the central portion, the extended portions being thinner than the central portion. Contacts connect to the extended portions of the heater portion and the modulator portion on a top and a bottom of the extended portions.

In accordance with another embodiment of the present invention, a semiconductor device includes a micro-ring resonator including a heating component and a modulator component. A center air cavity is located in a center of the micro-ring resonator, wherein the heating component and the modulator component are located about the center air cavity. A lateral air cavity extends from a bottom of the center air cavity, wherein the lateral air cavity extends radially from the center air cavity under the heating component and the modulator component.

In accordance with another embodiment of the present invention, a method for fabricating a semiconductor device includes forming a micro-ring resonator on a substrate, the micro-ring resonator including a semiconductor material having a central portion and extended portions, the extended portions being thinner than the central portion; defining a heater portion in a first region of the micro-ring resonator; defining a modulator portion in a second region of the micro-ring resonator; and forming contacts on a top and a bottom of the extended portions to the heater portion and the modulator portion.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a cross-sectional view showing a semiconductor device that forms a micro-disk (micro-ring) resonator with a patterned thin semiconductor layer on a silicon-on-insulator (SOI) substrate, in accordance with an embodiment of the present invention;

FIG. 2 is a cross-sectional view showing a dielectric layer formed and polished over the SOI substrate, in accordance with an embodiment of the present invention;

FIG. 3 is a cross-sectional view showing metal contact pads formed in contact with device regions, in accordance with an embodiment of the present invention;

FIG. 4 is a cross-sectional view showing a dielectric layer formed and polished over the SOI substrate, in accordance with an embodiment of the present invention;

FIG. 5 is a cross-sectional view showing a separate carrier wafer/substrate having a dielectric layer formed thereon, in accordance with an embodiment of the present invention;

FIG. 6 is a cross-sectional view showing a trench formed and filled in the dielectric layer and the separate carrier substrate, in accordance with an embodiment of the present invention;

FIG. 7 is a cross-sectional view showing the separate carrier wafer/substrate bonded to the SOI substrate, in accordance with an embodiment of the present invention;

FIG. 8 is a cross-sectional view showing a fused wafer flipped, in accordance with an embodiment of the present invention;

FIG. 9 is a cross-sectional view showing the handle wafer (substrate) removed from the SOI substrate to expose the insulating layer, in accordance with an embodiment of the present invention;

FIG. 10 is a cross-sectional view showing contacts formed in a heater portion and a modulator portion, in accordance with an embodiment of the present invention; and

FIG. 11 shows a top view and a cross-sectional view (not to scale) of a micro-disk resonator having in the heater portion and the modulator portion with a central air cavity and undercut cavities (undercuts), in accordance with an embodiment of the present invention.

### DETAILED DESCRIPTION

In accordance with embodiments of the present invention, devices and methods are described which include micro-disk or micro-ring resonators, which are photonic devices that include a circular disk-shaped waveguide fabricated from a high refractive index material such as, e.g., silicon. The disk may be surrounded by a lower refractive index material, often air or silicon dioxide. Light may be coupled into the disk through an adjacent waveguide positioned close to the disk's edge. In some embodiments, micro-disk resonators can have light circulate around the disk's perimeter by total internal reflection. Resonant frequencies of these modes may depend on the disk's size and material properties. When the wavelength of the input light matches a resonant mode, the light may build up in intensity within the disk.

Micro-disk resonators find applications in various photonic devices and systems. Micro-disk resonators may be employed as optical filters, where specific wavelengths are selectively transmitted or reflected. Micro-disk resonators may be employed in optical switching and modulation applications.

The fabrication of micro-disk resonators includes semiconductor processing techniques. This may include lithography to define the disk shape, etching to create the disk structure, and deposition steps to form cladding layers or electrodes for active devices. Micro-disk resonators may be integrated with other photonic and electronic components on a single chip. This integration may enable the development of complex photonic circuits for applications in optical communication, sensing, and information processing.

A micro-disk resonator or modulator is highly sensitive to operation parameters, like environment temperature. In accordance with an embodiments a heater is integrated inside the ring resonator and an undercut is introduced to isolate a waveguide from a substrate. A new structure is provided that integrates both a heater and undercut into tunable ring modulator in more compact size using a heterogeneous integration method.

In accordance with embodiments of the present invention, a semiconductor device includes a micro-ring resonator that includes a heating component and a modulator component. A center air cavity is located in a center of the micro-ring resonator, wherein the heating component and the modulator component are located about the center air cavity. A lateral air cavity extends from the bottom of the center air cavity. The lateral air cavity extends radially from the center air cavity under the heating component and the modulator component.

In other embodiments, a method for fabricating a micro-ring resonator includes a waveguide formed on a silicon-on-insulator (SOI) substrate. Diffusion regions are patterned into a thin semiconductor layer of the SOI substrate. The diffusion regions include a central thicker portion and thinner extended portions which extend from the central thicker portion. One diffusion region is associated with a heating component and another is associated with a modulator component.

The heating component has its extended portions highly doped (e.g., P++ or N++). The modulator component has its extended portions highly doped (e.g., one P++ and the other N++). A dielectric layer is deposited over the diffusion regions. Frontside metal contact pads are fabricated to connect with the extended portions for the diffusion regions. A top surface of the SOI substrate is prepared for hybrid bonding. A separate carrier wafer is prepared with the formation of a dielectric layer on the carrier wafer. The carrier wafer is etched to form a trench. The trench is filled with a sacrificial material, which will be used for formation of an undercut/cavity in later steps. A wafer to wafer fusion bonding process is performed to join the top surface of the SOI substrate with the dielectric layer and sacrificial material of the separate carrier wafer.

The wafer is then flipped and the SOI substrate is removed. Backside metal contacts are formed and connect to the metal contacts pads. The sacrificial material is removed to form an air cavity and undercut. The air cavity is centrally disposed through the micro-ring resonator and includes a heater side and a modulator side. The undercut is disposed below both the heater side and the modulator side.

A method for fabricating a micro-ring resonator includes patterning diffusion regions into a thin semiconductor layer of a silicon-on-insulator (SOI) substrate, wherein the diffusion regions include a central thicker portion and thinner extended portions; depositing a dielectric layer over the diffusion regions; fabricating frontside metal contact pads to connect with the extended portions of the diffusion regions; preparing a top surface of the SOI substrate for hybrid bonding; preparing a separate carrier wafer with a dielectric layer and a sacrificial material; performing a wafer-to-wafer fusion bonding process to join the top surface of the SOI substrate with the separate carrier wafer; removing the SOI substrate to expose an insulating layer; forming backside metal contacts to connect with the frontside metal contact pads; and removing the sacrificial material to form an air cavity and an undercut.

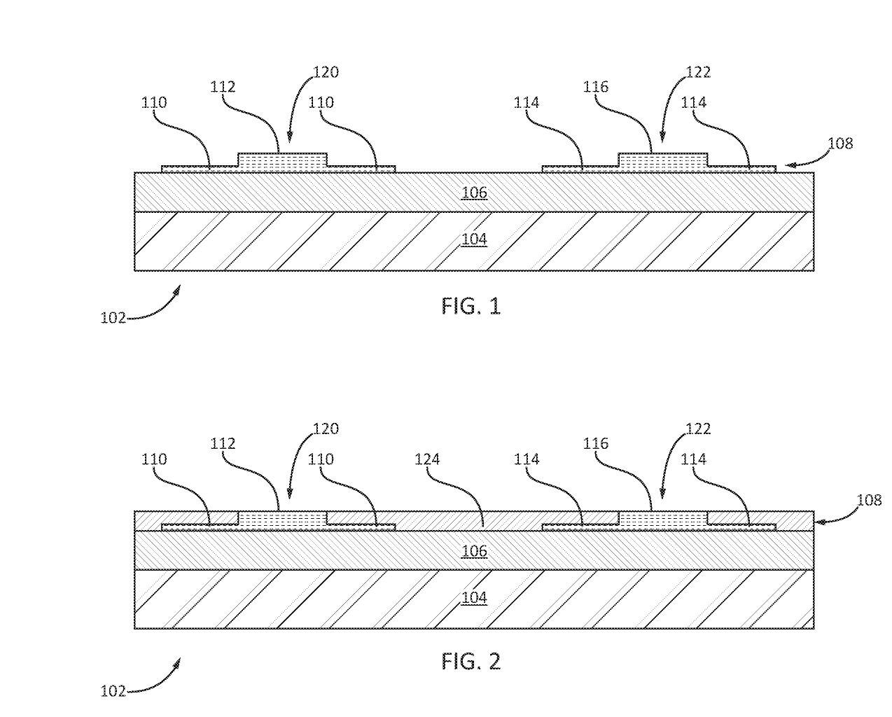

Referring now to the drawings in which like numerals represent the same or similar elements and initially to FIG. 1, a silicon-on-insulator (SOI) substrate 102 is shown in accordance with an embodiment of the present invention. The SOI substrate 102 is processed for use in a micro-disk resonator that includes a micro-disk having a heater portion and a modulator portion. The SOI substrate 102 may include a layered structure including a thin layer 108, e.g., of silicon or other semiconductor material, on top of an insulating layer 106. The insulating layer 106 can include, e.g., silicon dioxide (SiO₂), also referred to as a buried oxide (BOX), although other dielectric materials can be employed. The insulating layer 106 may be formed on a handle wafer 104 (or substrate). The thin layer 108, can be referred to as a device layer used for fabricating semiconductor devices, and in particular, for forming device regions 120, 122 while the insulating layer 106 provides electrical isolation from the underlying handle wafer 104.

The handle wafer 104 can have a single layer or multiple layers. The handle wafer 104 can include a monocrystalline semiconductor. In one example, the handle wafer 104 can include a silicon-containing material. Illustrative examples of Si-containing materials suitable for the handle wafer 104 can include, but are not limited to Si, SiGe, SiGeC, SiC and multi-layers thereof. Although silicon is the predominantly used semiconductor material in wafer fabrication, alternative semiconductor materials can be employed as additional layers, such as, but not limited to, germanium, gallium arsenide, gallium nitride, silicon germanium, cadmium telluride, zinc selenide, etc.

While the thin layer 108 is preferably silicon, the thin layer 108 can include other semiconductor materials. For example, the thin layer 108 can have a single layer or multiple layers. The thin layer 108 can include a monocrystalline semiconductor. In one example, the thin layer 108 can include a silicon-containing material. Illustrative examples of Si-containing materials suitable for the thin layer 108 can include, but are not limited to, Si, SiGe, SiGeC, SiC and multi-layers thereof.

Device regions 120 and 122 are patterned using lithographic processing. Lithographic processing can include forming an etch mask and etching the thin layer 108 down to the insulating layer 106 to define the device regions 120 and 122. Then, another etch mask can be formed over central portions 112, 116 and a timed etch performed to thin out the thin layer 108 to form extended portions 110 and 114. The etching processes can include, e.g., a reactive ion etch (RIE).

The device regions 120 and 122 can be referred to as a rib waveguided structure. The extended portions 110 and 114 are doped with N or P dopants (only one conductivity type dopant from the device region 120). In one example, the extended portions 110 can be employed for a heater and can doped on both ends with either N++ dopants or P++ dopants.

In another example, extended portions 114 are doped with P+ or P++ dopants on one side of the device region 122 and N+ or N++ on the other side of the device region 122. Dopants from the extended portions 114 diffuse into the central portion 116 to create to grow a PN junction for active modulation on a modulator portion. Dopant masks can be employed to direct the placement of dopants. The device regions 120 and 122 can be doped together and/or separately using ion implantation methods or other doping methods. In an embodiment, the device regions 120 and 122 can include N type dopants (e.g., P, As, etc.) and/or P type dopants (e.g., B, Ga, etc.).

Referring to FIG. 2, a dielectric layer 124 is deposited over the device regions 120 and 122. The dielectric layer 124 can be planarized, e.g., using a chemical mechanical polish (CMP) down to the central portions 112, 116 and expose the central portions 112, 116. The dielectric layer 124 covers the extended portions 110 and 114. The dielectric layer 124 can include materials such as, e.g., silicon dioxide, silicon nitride, a polymer or other dielectric materials.

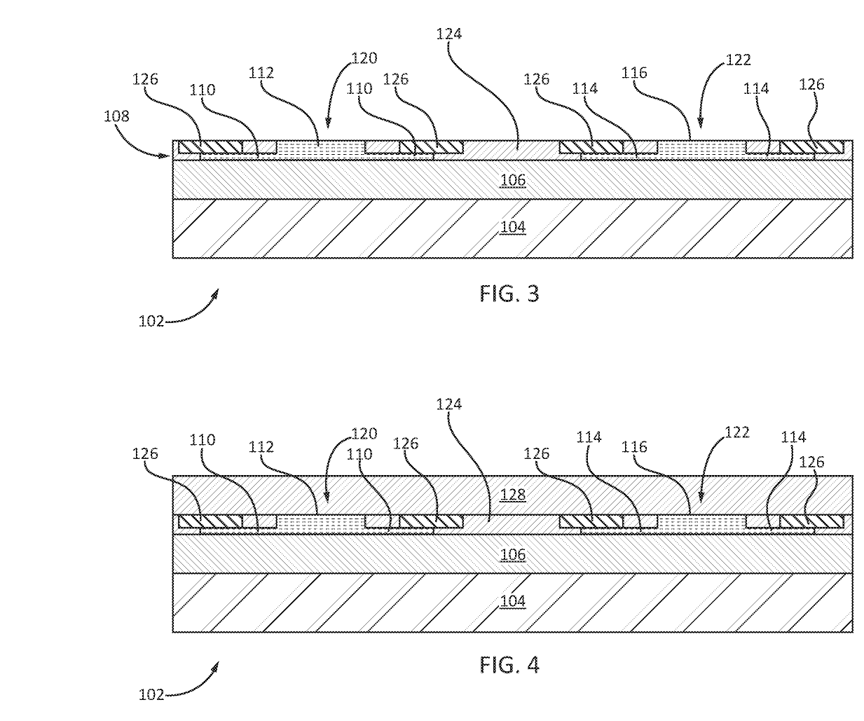

Referring to FIG. 3, metal contact pads 126 can be formed by patterning and etching the dielectric layer 124 to form contact openings that expose the extended portions 110, 114. A conductive fill is performed to fill the contact openings. The conductive fill can include materials, such as, e.g., W, Cu, Co, and alloys or combinations of these and other conductive materials. In a particularly useful embodiment, the conductive fill includes W. The conductive fill can be formed using a deposition method, such as, e.g., chemical vapor deposition (CVD), plasma enhanced CVD (PECVD), atomic layer deposition (ALD) or any other suitable deposition method. The conductive fill is planarized, e.g., by CMP, to form the metal contact pads 126.

The metal contact pads 126 can directly contact the underlying extended portions 110, 114 or a silicide liner and/or diffusion barrier can be formed. For example, a silicide liner, such as Ti, Ni, NiPt can be deposited before a conductive fill is performed to form the metal contact pads 126. A diffusion barrier can also be formed prior to the conductive fill. The diffusion barrier can include, e.g., TiN, TaN, or similar materials. It should be understood that horizontal interfaces between the metal contact pads 126 and the extended portions 110, 114 can be controlled to increase or decrease contact resistance between the extended portions 110, 114 and the metal contact pads 126 by increasing or decreasing a length of contact between these two components.

The metal contact pads 126 also need to keep a distance from an adjacent sidewall of the central portions 112 or 116 to prevent shorts. The metal contact pads 126 are formed from a frontside of the SOI substrate 102.

Referring to FIG. 4, a dielectric layer 128 is deposited over the device regions 120, 122 and the metal contact pads 126. The dielectric layer 128 can be planarized, e.g., using CMP to prepare a free surface of the dielectric layer 128 for hybrid bonding in later steps. The dielectric layer 124 can include materials such as, e.g., silicon dioxide, silicon nitride, a polymer or other dielectric materials.

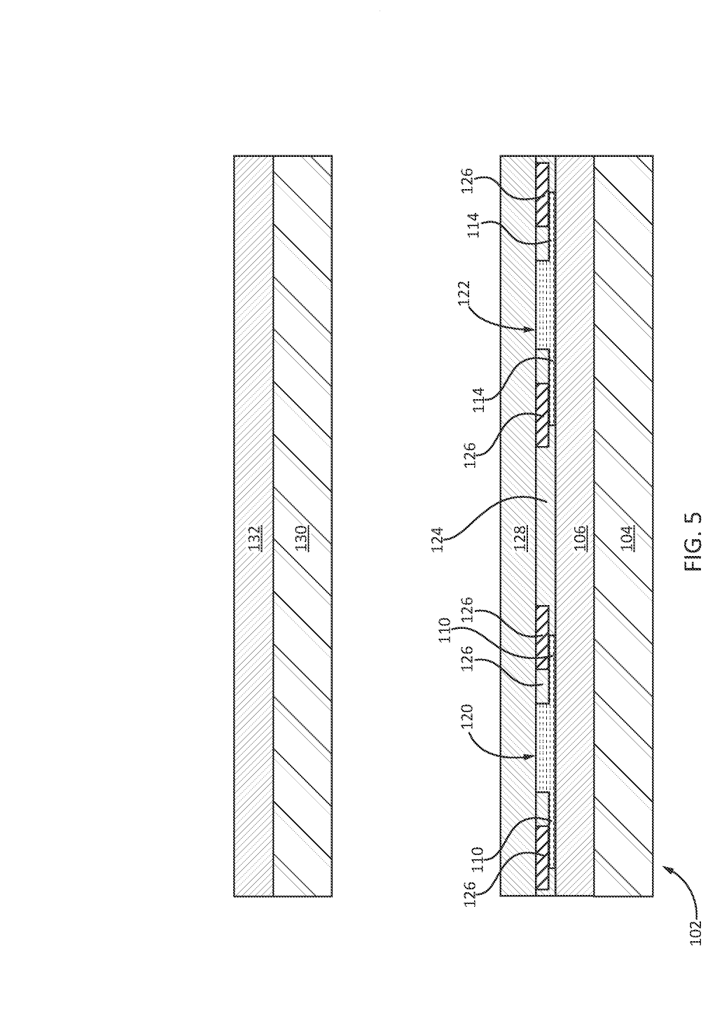

Referring to FIG. 5, a dielectric layer 132 is deposited on a separate carrier wafer 130. The carrier wafer 130 can have a single layer or multiple layers. The carrier wafer 130 can include a monocrystalline semiconductor. In one example, the carrier wafer 130 can include a silicon-containing material. Illustrative examples of Si-containing materials suitable for the handle wafer 104 can include, but are not limited to Si, SiGe, SiGeC, SiC and multi-layers thereof. Although silicon is the predominantly used semiconductor material in wafer fabrication, alternative semiconductor materials can be employed as additional layers, such as, but not limited to, germanium, gallium arsenide, gallium nitride, silicon germanium, cadmium telluride, zinc selenide, etc. The dielectric layer 132 can be deposited over the carrier wafer 130. The dielectric layer 132 can be planarized, e.g., using CMP, to prepare a free surface of the dielectric layer 132 for hybrid bonding in later steps. The dielectric layer 132 can include materials such as, e.g., silicon dioxide, silicon nitride, a polymer or other dielectric materials.

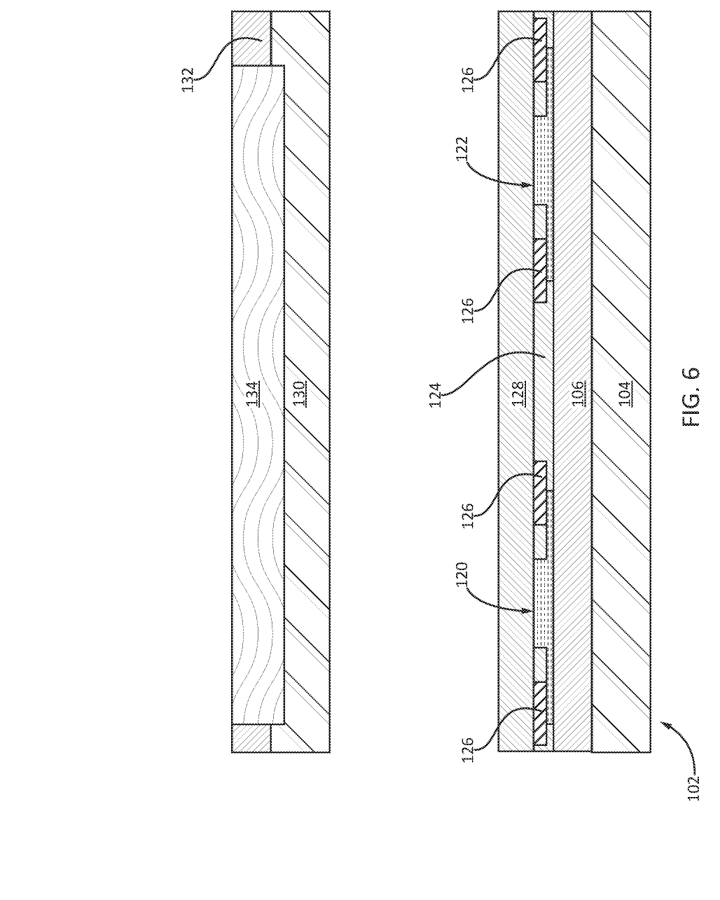

Referring to FIG. 6, an etch mask (not shown) can be patterned over the dielectric layer 132 and a trench can be etched into the dielectric layer 132 and into the carrier wafer 130. The trench is filled with a sacrificial dielectric material 134 and planarized (e.g., using CMP). The sacrificial dielectric material 134 includes a material that is selectively etchable relative to the dielectric layer 132 and the carrier wafer 130. The sacrificial dielectric material 134 can include an oxide, a nitride or other material depending on the materials selected for the dielectric layer 132 and the carrier wafer 130.

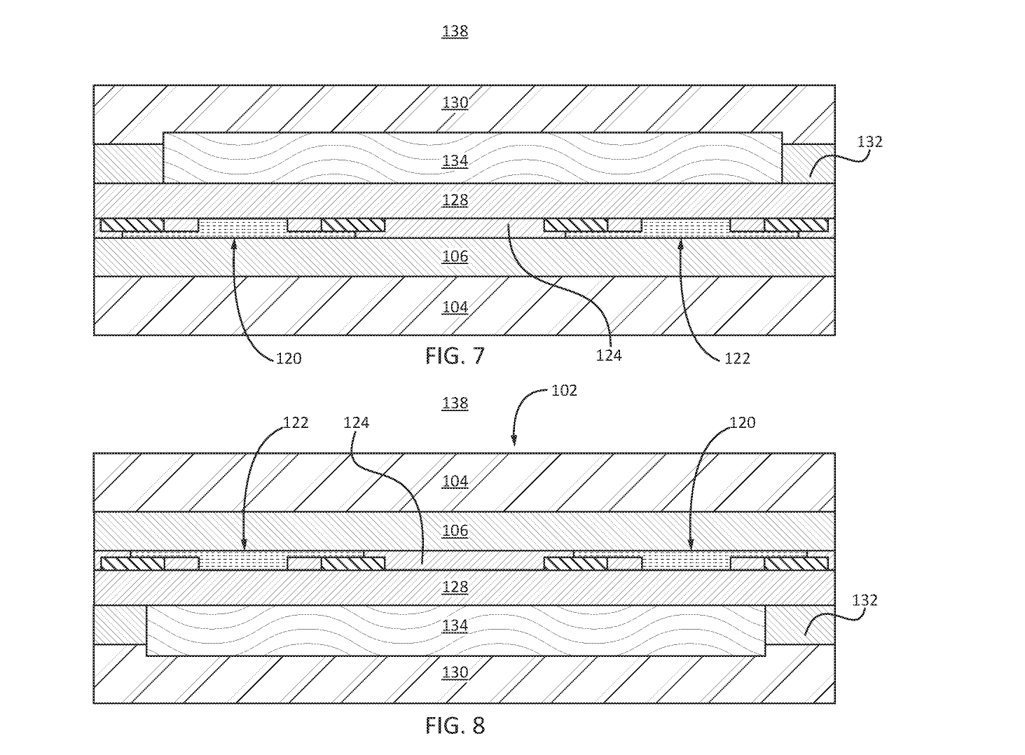

Referring to FIG. 7, a wafer-to-wafer fusion bond (hybrid bond) is performed between the dielectric layer 132 and the dielectric layer 128. This includes flipping a wafer and aligning it with the other wafer so that the dielectric layers 128 and 132 are in contact. Fusion bonding includes bringing two highly polished and cleaned dielectric surfaces into close contact and allowing them to adhere through van der Waals forces and chemical bonds. The process may begin with surface preparation, which can include chemical cleaning to remove contaminants and activation treatments to increase surface reactivity. In some cases, the surfaces may be exposed to plasma or chemical solutions to create hydroxyl groups that can form strong bonds.

The dielectric layers 128 and 132 may then be aligned and pressed together under controlled temperature and pressure conditions. The initial contact may occur at room temperature, with subsequent annealing at elevated temperatures to strengthen the bond. The annealing temperature may vary depending on the materials involved, but can range from 200°C to over 1000°C for some applications.

During the annealing process, the interface between the dielectric layers 128 and 132 undergoes chemical reactions, leading to the formation of covalent bonds. For silicon dioxide layers, this can include condensation of silanol groups (Si-OH) to form siloxane bonds (Si-O-Si). The bonding process may also cause the diffusion of water molecules away from the interface, further strengthening the bond.

In some embodiments, the fusion bonding process may be performed in a vacuum or inert atmosphere to prevent the formation of voids or trapped gases at the interface. The bonding strength may be influenced by factors such as surface roughness, cleanliness, and the presence of intermediate layers. The fusion bonding process results in a fusion bonded wafer 138.

Referring to FIG. 8, the fusion bonded wafer 138 is flipped. Once flipped, the SOI substrate 102 is on the top so that processing can continue on a backside of the SOI substrate 102.

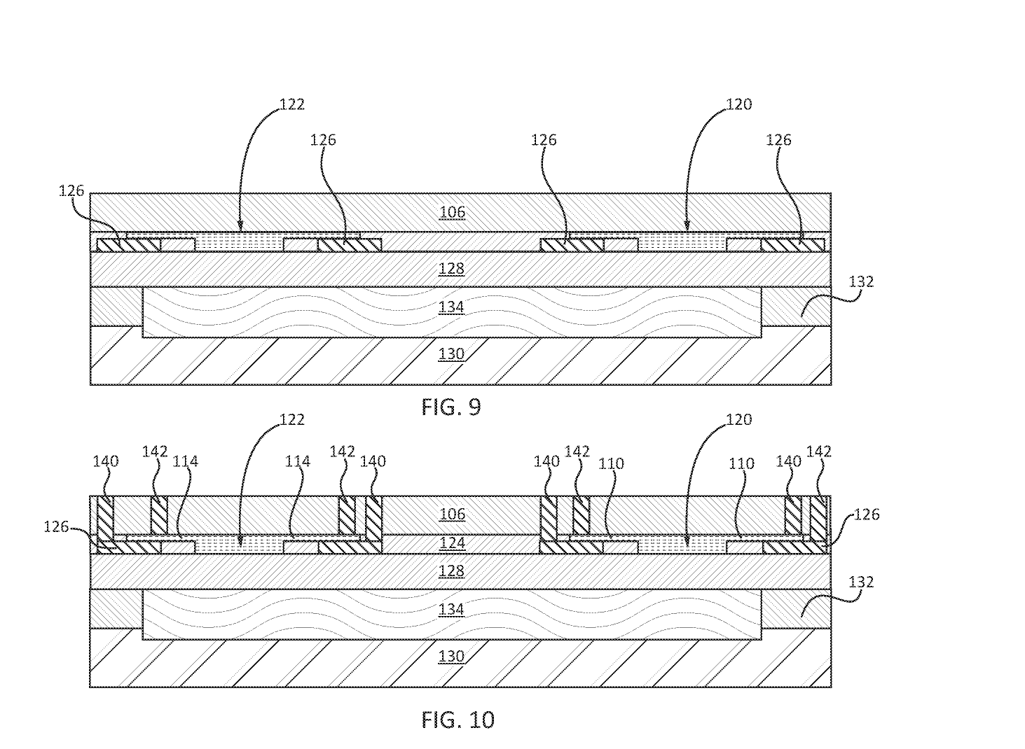

Referring to FIG. 9, an etch process or a planarization process can be performed to remove the handle wafer 104 (substrate) from the SOI substrate 102. The removal of the handle wafer 104 exposes the insulating layer 106 for further processing.

Referring to FIG. 10, a patterning process or processes are performed to etch the insulating layer 106 to expose the extended portions 110 and 114 from a backside. The patterning process(es) can include the use of a photoresist mask and lithography process. A photoresist layer (not shown) may be deposited on top of the insulating layer 106. The photoresist can then be exposed to light through a photomask that defines the desired pattern for contact openings. The insulating layer 106 is etched, e.g., by RIE, to form contact openings that expose the extended portions 110, 114. As part of a same or different etch process contact openings are formed through the insulating layer 106 to expose the metal contact pads 126.

A conductive fill is performed to fill the contact openings. The conductive fill can include materials, such as, e.g., W, Cu, Co, and alloys or combinations of these and other conductive materials. In a particularly useful embodiment, the conductive fill includes W. The conductive fill can be formed using a deposition method, such as, e.g., CVD, PECVD, ALD or any other suitable deposition method. The conductive fill is planarized, e.g., by CMP, to form metal contacts 140 and 142.

The metal contacts 142 can directly contact the underlying extended portions 110, 114 or a silicide liner and/or diffusion barrier can be formed. For example, a silicide liner, such as Ti, Ni, NiPt can be deposited before the conductive fill is performed to form the metal contacts 142. A diffusion barrier can also be formed prior to the conductive fill for contacts 140 and 142. The diffusion barrier can include, e.g., TiN, TaN, or similar materials.

It should be understood that metal contacts 142, and metal contacts 140 through metal contact pads 126, provide two connections at each connection point in a heater portion and a modulator portion of a micro-disk resonator. The double connections reduce contact resistance resulting in performance gain of both the heater and the modular functions.

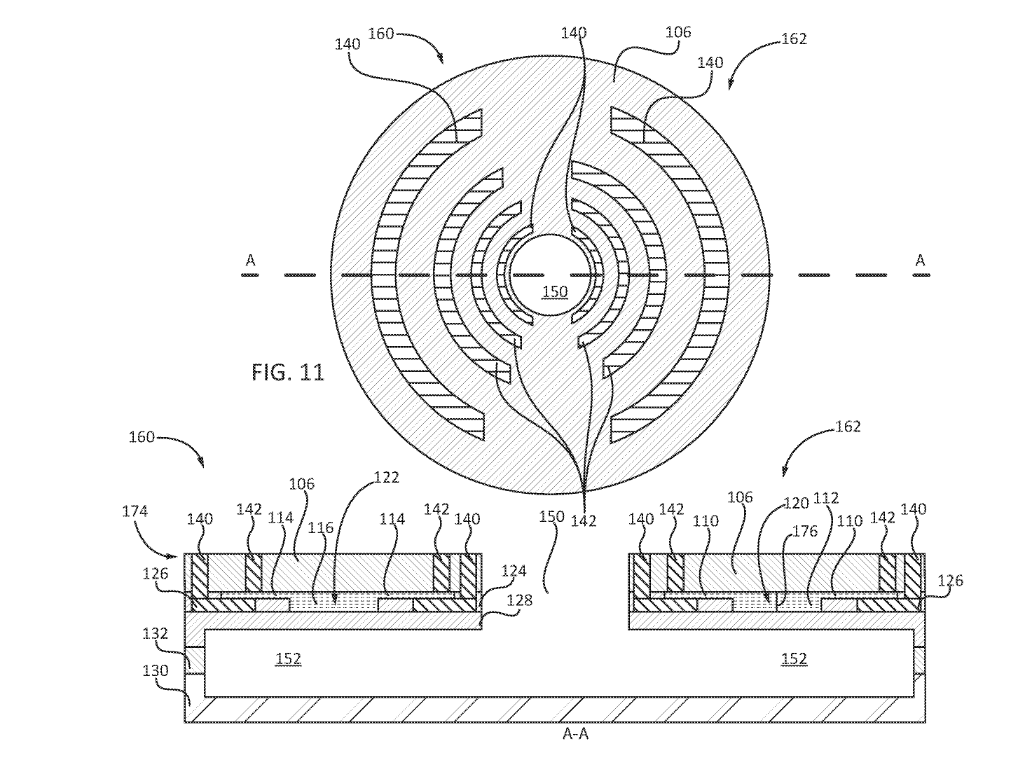

Referring to FIG. 11, a top view 172 and a cross-sectional view 174 taken at section line A-A in the top view 172 depicts a micro-disk or micro-ring resonator 170 in accordance with embodiments of the present invention. The top view 172 and the cross-sectional view 174 are not to scale. The micro-ring resonator 170 includes a heater portion 160 and a modulator portion 162. It should be understood that the semiconductor material for the device regions 120, 122 form a continuous ring while the contacts 140, 142 include breaks in continuity as shown in the top view 172. The modulator portion 162 forms a PN junction 176 between opposing extended portions 110 and within the central portion 114. The heater portion 160 does not include a PN junction and instead relies on resistive properties of the doped device region 122 to generate heat. The heat of the heater portion 160 can be carefully controlled to control a temperature of the micro-ring resonator 170 to provide optimal operating conditions.

Referring to FIGS. 10 and 11, the processing of the structure depicted in FIG. 10, includes forming an etch mask using lithographic patterning. An etch process is performed to open up a central air cavity 150 by etching through the insulating layer 106, dielectric layer 124, and dielectric layer 128. This exposes the sacrificial dielectric material 134. A selective etch is performed to remove the sacrificial dielectric material 134 relative to the carrier wafer 130 and the insulating layer 106, dielectric layer 124, and dielectric layer 128. By removing the sacrificial dielectric material 134, undercuts 152 are formed which are in fluid communication with the central air cavity 150. The undercuts 152 and the air cavity 150 isolate the heater portion 160 to prevent heat loss through regions other than the semiconductor material of the micro-ring (e.g., device regions 120, 122).

By integrating the heater portion 160 with the modulator portion 162, temperature fluctuations in the operation of the resonator can be improved. In addition, a more compact-sized resonator is achieved with the integration of the heater portion and the modulator portion 162 in a single micro-ring/waveguide.

In accordance with the present embodiments, micro-ring resonators with integrated heaters provide enhanced functionality and performance in photonic integrated circuits. The heater portion 160 may be incorporated within the micro-ring structure to enable precise control of the resonator's optical properties through localized temperature modulation. The heater portion 160 employs doped semiconductor regions within the micro-ring waveguide itself. For example, heavily doped p-type or n-type regions may be created in portions of the ring to act as resistive heating elements when current is applied. This integrated heater design can allow for compact device footprints.

The heater portion 160 can enable dynamic tuning of the micro-ring's resonant wavelength by exploiting the thermo-optic effect in the waveguide material. As the temperature changes, the refractive index of the waveguide may shift slightly, altering the optical path length and resonance condition of the ring. This tuning capability can be useful for applications such as reconfigurable optical filters, switches, and modulators.

The heater portion 160 is thermally isolated from the carrier wafer 130 and surrounding structures to improve power efficiency. Air cavity 150 and/or undercuts 152 formed beneath and around the micro-ring, as described, can help confine heat to the waveguide region. This thermal isolation may permit lower power consumption and faster thermal response times and results in greater thermal control.

The heater design may be optimized to provide uniform heating across the micro-ring circumference. This can involve careful placement of doped regions and metal contacts to achieve even current distribution and heat generation. Uniform heating may help maintain the desired resonator mode shape and minimize unwanted optical effects.

In some embodiments, temperature sensors can be integrated alongside the heater portion to enable closed-loop control of the micro-ring temperature. This can allow for precise stabilization of the resonator's optical properties in the presence of ambient temperature fluctuations or other disturbances. The combination of integrated heater portions 160 with the modulator portion 162 (optical modulator) and other functional elements can enable multi-functional photonic components having a small footprint. This integration can be valuable for creating compact, reconfigurable photonic circuits for applications in optical communications, sensing, and signal processing.

Exemplary applications/uses to which the present invention can be applied include, but are not limited to semiconductor devices. Semiconductor devices can include processors, memory devices, application specific integrated circuits (ASICs), logic circuits or devices, combinations of these and any other circuit device. In such devices, one or more semiconductor devices can be included in a central processing unit, a graphics processing unit, and/or a separate processor- or computing element-based controller (e.g., logic gates, etc.). The semiconductor devices can include one or more on-board memories (e.g., caches, dedicated memory arrays, read only memory, etc.). In some embodiments, the semiconductor devices can include one or more memories that can be on or off board or that can be dedicated for use by a hardware processor subsystem (e.g., ROM, RAM, basic input/output system (BIOS), etc.).

In some embodiments, the semiconductor devices can include and execute one or more software elements. The one or more software elements can include an operating system and/or one or more applications and/or specific code to achieve a specified result. In still other embodiments, the semiconductor devices can include dedicated, specialized circuitry that perform one or more electronic processing functions to achieve a specified result. Such circuitry can include one or more field programmable gate arrays (FPGAs), and/or programmable applications programmable logic arrays (PLAs).

It is to be understood that aspects of the present invention will be described in terms of a given illustrative architecture; however, other architectures, structures, substrate materials and process features and steps can be varied within the scope of aspects of the present invention.

It will also be understood that when an element such as a layer, region or substrate is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

The present embodiments can include a design for an integrated circuit chip, which can be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer can transmit the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

Methods described herein can be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It should also be understood that material compounds will be described in terms of listed elements, e.g., SiGe. These compounds include different proportions of the elements within the compound, e.g., SiGe includes SiₓGe₁₋ₓ where x is less than or equal to 1, etc. In addition, other elements can be included in the compound and still function in accordance with the present principles. The compounds with additional elements will be referred to herein as alloys.

Reference in the specification to “one embodiment” or “an embodiment”, as well as other variations thereof, means that a particular feature, structure, characteristic, and so forth described in connection with the embodiment is included in at least one embodiment. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper,” “top,” “bottom” and the like, can be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein can be interpreted accordingly. In addition, it will also be understood that when a layer is referred to as being “between” two layers, it can be the only layer between the two layers, or one or more intervening layers can also be present.

It will be understood that, although the terms first, second, etc. can be used herein to describe various elements, these elements should not be limited by these terms. These terms are only used to distinguish one element from another element. Thus, a first element discussed below could be termed a second element without departing from the scope of the present concept.

Having described preferred embodiments of devices and methods (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A semiconductor device, comprising:
a micro-ring resonator including a semiconductor ring having a heater portion and a modulator portion integrally formed therein;
wherein the semiconductor ring includes a central portion and extended portions radially inside and radially outside the central portion, the extended portions being thinner than the central portion; and
contacts connecting to the extended portions of the heater portion and the modulator portion on a top and a bottom of the extended portions.

2. The semiconductor device of claim 1, further comprising contact pads that connect the contacts to the extended portions.

3. The semiconductor device of claim 1, wherein the extended portions for the heater portion include a same conductivity type dopant.

4. The semiconductor device of claim 1, wherein the extended portions for the modulator portion include an opposite dopant conductivity type to form a PN junction in the central portion of the modulator portion.

5. The semiconductor device of claim 1, wherein the extended portions on each side of the central portion include two contact connections.

6. The semiconductor device of claim 5, wherein the two contact connections include a frontside contact and a backside contact.

7. The semiconductor device of claim 1, further comprising, a center air cavity located in a center of the micro-ring resonator.

8. The semiconductor device of claim 7, further comprising, an undercut region extending radially from the center air cavity under the heater portion and the modulator portion.

9. A semiconductor device, comprising:
a micro-ring resonator including a heating component and a modulator component;
a center air cavity located in a center of the micro-ring resonator, wherein the heating component and the modulator component are located about the center air cavity; and
a lateral air cavity extending from a bottom of the center air cavity, wherein the lateral air cavity extends radially from the center air cavity under the heating component and the modulator component.

10. The semiconductor device of claim 9, wherein the heating component includes:
a central portion and extended portions, wherein the extended portions are thinner than the central portion; and
first metal contacts connected to the extended portions.

11. The semiconductor device of claim 10, wherein the extended portions are doped with a same conductivity type dopant.

12. The semiconductor device of claim 10, wherein the first metal contacts include frontside contacts and backside contacts.

13. The semiconductor device of claim 9, wherein the modulator component includes:
a central portion and extended portions, wherein the extended portions are thinner than the central portion; and
second metal contacts connected to the extended portions.

14. The semiconductor device of claim 13, wherein the extended portions on each side of the central portion are doped with opposite conductivity type dopants.

15. The semiconductor device of claim 14, wherein the second metal contacts include frontside contacts and backside contacts.

16. A method for fabricating a semiconductor device, comprising:
forming a micro-ring resonator on a substrate, the micro-ring resonator including a semiconductor material having a central portion and extended portions, the extended portions being thinner than the central portion;
defining a heater portion in a first region of the micro-ring resonator;
defining a modulator portion in a second region of the micro-ring resonator; and
forming contacts to the heater portion and the modulator portion on a top and a bottom of the extended portions.

17. The method of claim 16, wherein defining the heater portion includes doping a first set of the extended portions with a same conductivity type dopant.

18. The method of claim 16, wherein defining the modulator portion includes doping a second set of the extended portions with opposite conductivity type dopants on opposite sides of the central portion.

19. The method of claim 16, further comprising:
forming a center air cavity in a center of the micro-ring resonator; and
forming an undercut in fluid communication with the center air cavity, wherein the undercut extends radially from the center air cavity under the heater portion and the modulator portion.

20. The method of claim 16, wherein forming contacts includes forming frontside contacts and backside contacts for each of the heater portion and the modulator portion.
